(19) United States
(12) Patent Application Publication
(10) Pub. No.: US 2007/0176392 A1
(43) Pub. Date: Aug. 2, 2007

(54) Motorcycle provided with a steering damper

(75) Inventors: Georg Schiffer, Weichs (DE); Gerrit Heyl, Gauting (DE); Jens Priese, Unterfoehring (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/729,236

(22) Filed: Mar. 28, 2007

Related U.S. Application Data
(63) Continuation of application No. PCT/EP05/11406, filed on Oct. 25, 2005.

(30) Foreign Application Priority Data
Nov. 10, 2004 (DE) 10 2004 054 188.4

(51) Int. Cl. F16F 9/53; B62K 21/00

(52) U.S. Cl. 280/272; 188/267.1

(57) ABSTRACT

Motorcycle having a steerable front wheel and a steering damper filled with a rheological fluid provided for damping steering movements of the front wheel.

This application is a Continuation of PCT/EP2005/011406, filed Oct. 25, 2005, and claims the priority of DE 10 2004 054 188.4, filed Nov. 10, 2004, the disclosures of which are expressly incorporated by reference herein.

### BACKGROUND AND SUMMARY OF THE INVENTION

The present invention relates to a motorcycle with a steering damper.

U.S. Pat. No. 6,708,795 discloses a motorcycle with a hydraulic steering damper. The steering damper has a hydraulic valve. The damping characteristic of the steering damper can be varied by varying the position of the valve body. The steering damper is arranged between the motorcycle frame and the fork and/or the handlebar and has the function of damping unwanted vibrations of the front wheel fork and/or impacts transmitted via the front wheel into the front wheel fork. In U.S. Pat. No. 6,708,795, control electronics are provided to regulate the damping characteristic of the steering damper as a function of various driving state parameters, e.g., vehicle speed and/or vehicle acceleration.

The object of the present invention is to create a motorcycle having a regulable steering damper that has a simple design and can be regulated well.

This object is achieved through a motorcycle having a steerable front wheel and a steering damper which is provided for damping steering movements of the front wheel, wherein the steering damper is a fluid damper filled with a rheological fluid. The “rheological fluid” may be, for example, an electrorheological fluid or a magnetorheological fluid, the viscosity of which is known to be variable by applying an electric and/or magnetic field.

The steering damper may be, for example, a piston-cylinder arrangement or something similar. With a steering movement, in general terms, “two components” of the steering damper are displaced toward one another or are rotated in relation to one another. Rheological fluid is forced from a first fluid volume of the steering damper into a second fluid volume of the steering damper or vice-versa by the displacement and/or rotation of the two components of the steering damper. The damping of the steering damper depends to a significant extent on the instantaneous viscosity, i.e., the flow resistance, of the steering damper.

With an electrorheological steering damper, an electric field permeating the electrorheological fluid is generated by an electronic system in a controlled manner. The viscosity of the electrorheological fluid and thus the damping characteristic of the steering damper can be varied by varying the electric field strength. Accordingly, a magnetic field permeating the magnetorheological fluid is generated by an electronic system with a magnetorheological steering damper. Similarly the viscosity of the fluid and thus the damping characteristic of the steering damper can be varied by varying the field strength of the magnetic field.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the basic principle of a steering damping arranged on a motorcycle;

FIG. 2 shows a schematic diagram of an electrorheological steering damper in accordance with an embodiment of the present invention; and

FIG. 3 shows a schematic diagram of a magnetorheological steering damper in accordance with another embodiment of the present invention.

### DETAILED DESCRIPTION

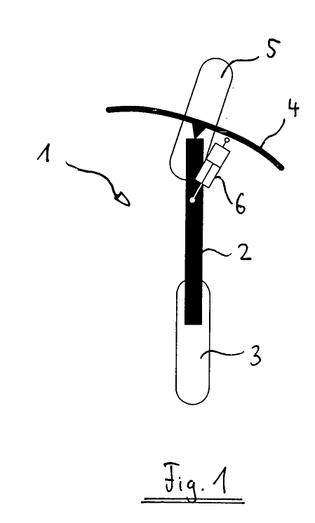

FIG. 1 shows a motorcycle 1 with a frame 2, a rear wheel 3 and a front wheel 5 steerable via a handlebar 4. A steering damper 6, shown here schematically as a piston cylinder arrangement, is arranged between the frame and the handlebar 4 and/or the fork.

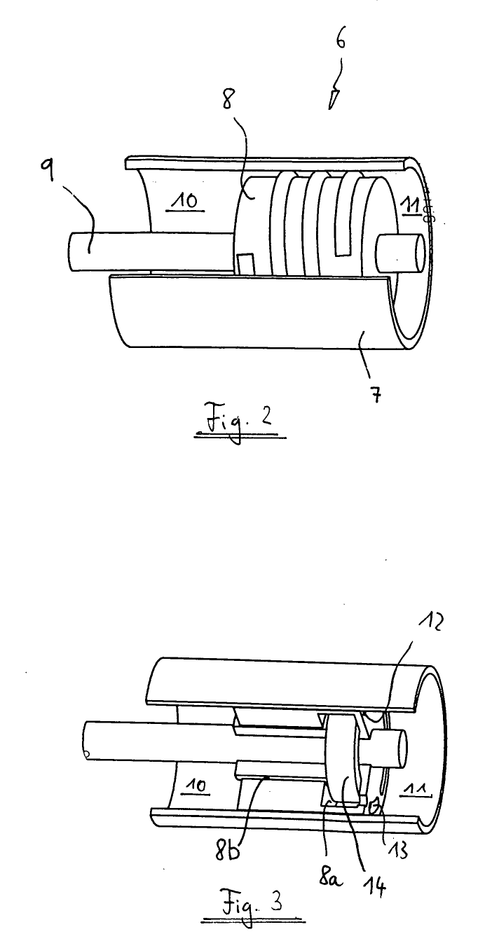

FIG. 2 shows a schematic diagram of an electrorheological steering damper 6. The steering damper 6 has a damper cylinder 7 which is made of an electrically conducting material. As an alternative to this, the damper cylinder 7 may be coated with an electrically conducting material. A damper piston 8 is arranged in the damper cylinder 7. A piston rod 9 protrudes from the damper piston 8. On the outside of the damper piston, a helical, i.e., spiral “gasket” is arranged and is in contact with the inside of the damper cylinder 7.

If the damper piston 8 is displaced in relation to the damper cylinder 7, the damper piston 8 forces fluid through the “fluid channel” formed by the helical, i.e., spiral “gasket” from a first cylinder space 10 into a second cylinder space 11 of the damping cylinder 7 or vice-versa. The “gasket,” i.e., the “fluid channel” formed by the gasket need not necessarily be helical, i.e., spiral in shape. The gasket forms only a “constriction” and/or a “throttle point.” The “longer” this throttle point, the greater is the damping effect in displacement of the damper piston 8.

The damping cylinder 7, the damper piston 8 and the piston rod 9 are made at least partially of an electrically conducting material. By applying an electric voltage to the damping cylinder 7 and/or to the damper piston 8 and the piston rod 9, an electric field is generated between the damper piston 8 and the damping cylinder 7 and therefore in the fluid channel formed by the gasket. By varying the electric voltage applied, the electric field strength and thus the viscosity of the electrorheological fluid in the cylinder chambers 10 and/or 11 are varied. The viscosity of the electrorheological fluid in turn determines to a significant extent the damping characteristic of the steering damper 6.

FIG. 3 shows a schematic diagram of a magnetorheological steering damper 6 which has a design very similar to that of the electrorheological steering damper illustrated in FIG. 2. The two cylinder spaces 10, 11 here are filled with a magnetorheological fluid. An annular gap 8a is provided in the damper piston 8, opening into the fluid space 11 through fluid channels 12, 13. The fluid space 11 is in fluid connection with the fluid space 10 via the fluid channels 12, 13, the annular gap 8a and an annular gap 8b connected thereto. Furthermore, an electromagnet 14 is integrated into the damper piston 8. A magnetic field can be generated in the two fluid channels 12, 13 and in the annular gap 8a by the electromagnet 14. The viscosity of the magnetorheological fluid flowing through the fluid channels 12, 13 and the annular gap 8a in displacement of the damper piston 8 is determined by the applied magnetic field strength. By varying the magnetic field strength, the damping characteristic of the magnetorheological steering damper 6 can be varied.

In the case of a rheological steering damper, the electric field strength and/or the magnetic field strength is regulated and/or controlled by an electronic system which is not shown in greater detail here. In the case of regulation, the damping characteristic can be regulated as a function of various driving state parameters, e.g., vehicle speed, throttle valve angle, the inclined position of the motorcycle, individual wheel rotational speeds, etc. Instead of regulation, a control system may also be provided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motorcycle, comprising:
a frame;
a steerable front wheel rotatably coupled to the frame; and
a steering damper coupled to the frame and arranged to dampen steering movements of the front wheel relative to the frame,
wherein the steering damper is a fluid damper containing a rheological damping fluid.

2. The motorcycle as claimed in claim 1, wherein the rheological damping fluid is an electrorheological fluid.

3. The motorcycle as claimed in claim 2, further comprising:
an electronic damping control system,
wherein the electronic damping control system is arranged to generate an electric field that permeates the electrorheological fluid.

4. The motorcycle as claimed in claim 3, wherein
the electronic damping control system is arranged to permit the electric field to be varied to obtain varying damping response from the steering damper.

5. The motorcycle as claimed in claim 1, wherein the rheological damping fluid is a magnetorheological fluid.

6. The motorcycle as claimed in claim 5, further comprising:
an electronic damping control system,
wherein the electronic damping control system is arranged to generate a magnetic field that permeates the magnetorheological fluid.

7. The motorcycle as claimed in claim 6, wherein
the electronic damping control system is arranged to permit the magnetic field to be varied to obtain varying damping response from the steering damper.

8. A motorcycle steering damper, comprising:
a steering damper body;
a fluid damping assembly housed within the steering damper body; and
a rheological damping fluid in the steering damper body which passes at least one of through or around the fluid damping assembly to dampen motion of the fluid damping assembly relative to the steering damper body,
wherein the steering damper body and the fluid damping assembly are adapted to be coupled between a frame of a motorcycle and a steerable front wheel of the motorcycle to dampen steering movements of the front wheel relative to the frame.

9. The motorcycle steering damper as claimed in claim 8, wherein the rheological damping fluid is an electrorheological fluid.

10. The motorcycle steering damper as claimed in claim 9, further comprising:
an electronic damping control system,
wherein the electronic damping control system is arranged to generate an electric field that permeates the electrorheological fluid.

11. The motorcycle steering damper as claimed in claim 10, wherein
the electronic damping control system is arranged to permit the electric field to be varied to obtain varying damping response from the steering damper.

12. The motorcycle steering damper as claimed in claim 8, wherein the rheological damping fluid is a magnetorheological fluid.

13. The motorcycle steering damper as claimed in claim 12, further comprising:
an electronic damping control system,
wherein the electronic damping control system is arranged to generate a magnetic field that permeates the magnetorheological fluid.

14. The motorcycle as claimed in claim 13, wherein
the electronic damping control system is arranged to permit the electric field to be varied to obtain varying damping response from the steering damper.
